(19) United States
(12) Patent Application Publication
(10) Pub. No.: US 2016/0007792 A1
(43) Pub. Date: Jan. 14, 2016

(54) A METHOD AND APPARATUS FOR MAKING COFFEE BEVERAGE

(71) Applicant: KONINKLIJKE PHILIPS N.V., Eindhoven (NL)

(72) Inventor: JINGWEI TAN, EINDHOVEN (NL)

(21) Appl. No.: 14/772,574

(22) PCT Filed: Feb. 21, 2014
(86) PCT No.: PCT/IB2014/059147

§ 371 Date: Sep. 3, 2015

(30) Foreign Application Priority Data
Mar. 7, 2013 (CN) PCT/CN2013/072318

(51) Int. Cl. A47J 31/00; A47J 31/42; A23F 5/26

(52) U.S. Cl. CPC A47J 31/002; A23F 5/262; A47J 31/42

(57) ABSTRACT

The present invention proposes a method for making coffee beverage using a home used coffee machine comprises warming up coffee materials before brewing; grinding coffee beans into coffee grounds; and brewing at least part of said coffee materials to make the coffee beverage; wherein said coffee materials are coffee beans and/or coffee grounds. The present invention also provides apparatus for making coffee using the above described method.

### FIELD OF THE INVENTION

The present invention relates to coffee beverage making, and particularly to methods and apparatus for making coffee beverage with improved flavor.

### BACKGROUND OF THE INVENTION

Coffee beans are taken from a living plant, and as such, have a limited shelf life. Coffee beans contain volatile oils—chemicals that give coffee its characteristic flavor. Those oils are released by the roasting process and grinding the coffee beans speeds up the flavor loss even more. Therefore, many people select to store coffee beans or coffee grounds under a low temperature condition, for example in refrigerators, to extend the shelf life.

However, various initial temperatures of coffee beans or coffee grounds prior to brewing may affect the final flavor of the coffee beverage. For example, coffee beverage made from coffee beans kept in refrigerator may be flat and dull. This is because the low temperature of the coffee beans or coffee grounds may cause the brewing temperature to be unstable and makes full and good extraction hard to be achieved, and may result in unsatisfying flavor of coffee beverage.

### OBJECT AND SUMMARY OF THE INVENTION

Because of the issues stated above, it would be advantageous to adjust the initial temperature of coffee beans or coffee grounds prior to brewing to improve the flavor of coffee beverage.

In one aspect, a method for making coffee beverage using a home used coffee machine comprises warming up coffee materials before brewing; grinding coffee beans into coffee grounds; and brewing at least part of said coffee materials to make the coffee beverage. Said warming up operation in present disclosure may cause molecular of coffee materials to become active which may be helpful to extract more characteristic flavor-related chemicals during the brewing process.

Advantageously, said step of warming up is performed without changing a roasting level of said coffee materials. This is to avoid over roasting of the coffee materials.

Advantageously, said coffee materials are coffee beans and said step of warming up is performed before the step of grinding the coffee beans. By warming up the coffee beans, better extraction may be achieved during the brewing process.

Advantageously, said coffee materials are a mixture of coffee beans and coffee grounds and said step of warming up is performed while grinding. By warming up the mixture of coffee beans and coffee grounds, better extraction may be achieved during the brewing process.

Advantageously, said coffee materials are coffee grounds and said step of warming up is performed after grinding. By warming up the coffee grounds, better extraction may be achieved during the brewing process.

Advantageously, the above state method further comprises a determining step prior to said step of warming up, and said determining step comprises determining a warm-up temperature of said coffee materials and/or a lasting time during said step of warming up, based on weight, type, initial temperature of coffee materials or a desired flavor of said coffee beverage, wherein said warm-up temperature of the coffee materials is not higher than 190 degree Celsius. By using this method, various options may be provided to satisfy users with different flavor preferences.

Advantageously, said step of warming up comprises warming up 10 to 20 grams of coffee materials; wherein said step of brewing comprises brewing said 10 to 20 grams of coffee materials to make coffee beverage. This method provides an energy efficient solution to warm up only a limited amount of coffee materials enough to make one or two cups of coffee.

Advantageously, said step of warming up comprises warming up said coffee materials at a first temperature; warming up at least a portion of said coffee materials at a second temperature, with said second temperature higher than said first temperature; wherein said step of brewing comprises brewing said at least a portion of the coffee materials to make coffee beverage. This method provides an energy efficient solution to warm up the coffee materials to a higher temperature right before brewing.

In one embodiment, a home used coffee machine, comprises a warming-up unit, configured to warm up coffee materials before brewing; a grinding unit coupled with said warming-up unit, configured to grind coffee beans into coffee grounds; and a brewing unit, configured to brew coffee grounds into coffee beverage. Said warming up operation in present disclosure may cause molecular of coffee materials to become active which may be helpful to extract more characteristic flavor-related chemical contents when brewing.

Advantageously, said coffee materials are coffee beans and said warming-up unit is configured to warm up the coffee beans before grinding. By warming up the coffee beans, better extraction may be achieved during the brewing process.

Advantageously, said coffee materials are a mixture of coffee beans and coffee grounds, and said warming-up unit is configured to warm up the mixture while grinding. By warming up the mixture of coffee beans and coffee grounds, better extraction may be achieved during the brewing process.

Advantageously, said coffee materials are coffee grounds and said warming-up unit configured to warm up the coffee grounds after grinding. By warming up the coffee grounds, better extraction may be achieved during the brewing process.

Advantageously, the above state coffee machine further comprises a determining unit configured to determine a working mode of said warming-up unit based at least on weight, type, temperature of the coffee beans, or desired flavor of the coffee beverage, wherein said working mode comprises a warm-up temperature of the coffee materials and/or a lasting time during warming up of the coffee materials, wherein the warm-up temperature of the coffee materials is not higher than 190 degrees Celsius. By using this method, various options may be provided to satisfy users with different flavor preferences.

Advantageously, said warming-up unit is configured to warm up 10 to 20 grams of coffee materials and said brewing unit is configured to brew said 10 to 20 grams of coffee materials to make coffee beverage. This method provides an energy efficient solution to warm up only a limited amount of coffee materials enough to make one or two cups of coffee.

Advantageously, said warming-up unit is configured to warm up said coffee materials at a first temperature and warm up at least a portion of said coffee materials at a second temperature, with said second temperature higher than said first temperature; wherein said brewing unit is configured to brew said at least a portion of said coffee materials to make coffee beverage. This method provides an energy efficient solution to warm up the coffee materials to a higher temperature right before brewing.

By using the above stated methods or apparatus, brewing of warmed up coffee materials may be performed under a relative constant temperature because the temperature of the coffee materials may be closer to the brewing water temperature and may help to form relative stable and constant extraction process.

### BRIEF DESCRIPTION OF THE DRAWINGS

The above and other objects and features of the present invention will become more apparent from the following detailed description considered in connection with the accompanying drawings, in which:

FIG. 1 is a flowchart of a method for making coffee beverage in accordance with one embodiment of the present disclosure;

FIG. 2 shows a flowchart of a method for making coffee beverage in accordance with another embodiment of the present disclosure;

FIG. 3 shows a flowchart of a method for making coffee beverage in accordance with yet another embodiment of the present disclosure;

FIG. 4 shows a block diagram of a coffee machine in accordance to one embodiment of the present disclosure;

FIG. 5 shows a block diagram of a coffee machine in accordance to another embodiment of the present disclosure;

FIG. 6 shows a block diagram of a coffee machine in accordance to another embodiment of the present disclosure; and

FIG. 7 shows a block diagram of a coffee machine in accordance to yet another embodiment of the present disclosure.

### DETAILED DESCRIPTION

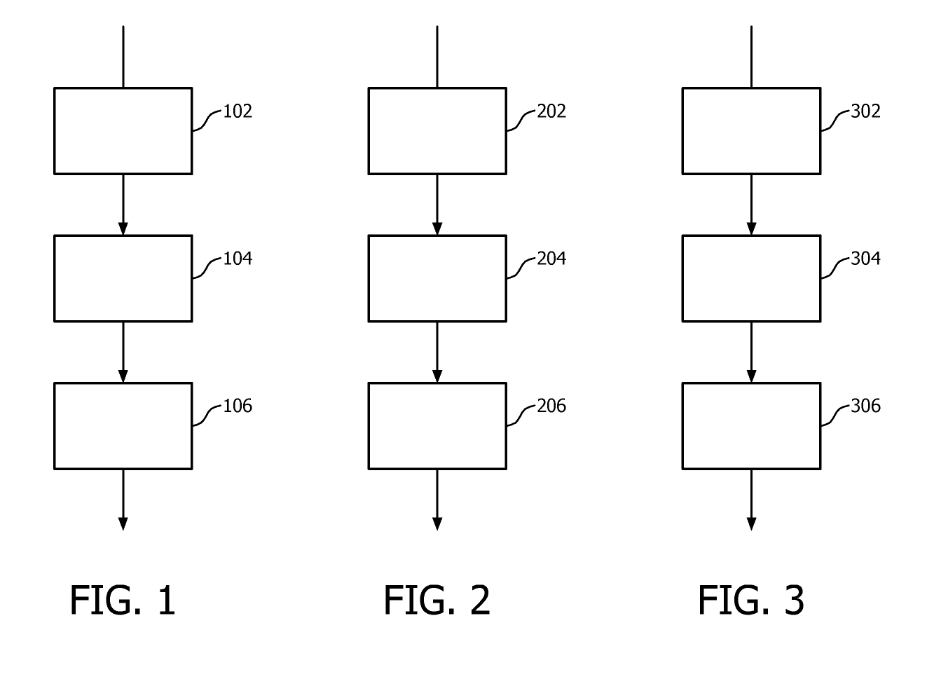

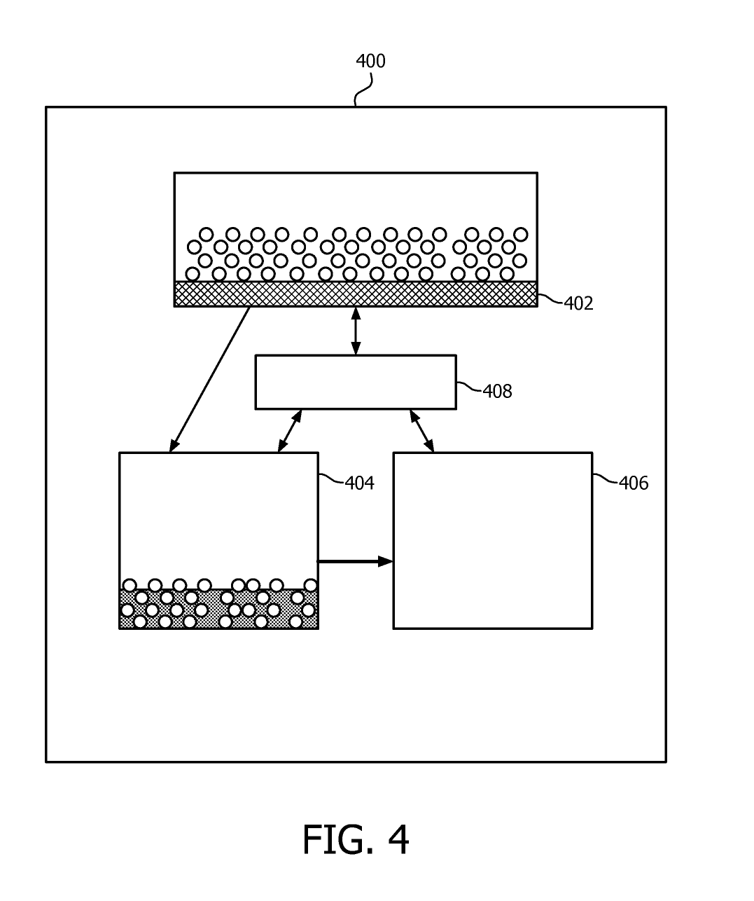

Reference will now be made to embodiments of the invention, one or more examples of which are illustrated in the figures. The embodiments are provided by way of explanation of the invention, and are not meant as a limitation of the invention. For example, features illustrated or described as part of one embodiment may be used with another embodiment to yield still a further embodiment. It is intended that the invention encompass these and other modifications and variations as come within the scope and spirit of the invention. FIG. 1 is a flowchart of a method for making coffee beverage according to one embodiment of the present disclosure. FIG. 4 illustrates a coffee machine 400 that may be configured to perform the method illustrated in FIG. 1.

At block 102, a warming up unit 402 of coffee machine 400 may be attached to a container of the coffee machine 400, and may be configured to warm up coffee beans in the container. At block 104, grinding unit 404 may be configured to grind the warmed up coffee beans into coffee grounds. At block 106, brewing unit 406 may be configured to brew the coffee grounds into coffee beverage.

In one embodiment, the coffee beans warmed up at block 102 may be beans of a pre-determined roasting level and said warming up operation performed by warming up unit 402 may not change the pre-determined roasting level of the coffee beans. Therefore, in one embodiment, a warm-up temperature of the coffee beans achieved by warming up unit 402 may be no higher than 190 degrees Celsius to avoid strong Maillard reaction that may change the roasting level of the beans.

In another embodiment, the coffee beans contained in the chamber may be half-roasted beans and warming up unit 402 may be configured to increase the warm-up temperature to achieve the pre-determined roasting level.

In another embodiment, coffee machine 400 may further comprise a determining unit 408 configured to determine the warm-up temperature based on a desired flavor of the coffee beverage. For example, if the desired flavor is stronger, the warm-up temperature may be higher.

In one embodiment, warm-up time of the coffee beans may be determined by the warm-up temperature, desired flavor of coffee beverage as well as many other factors including initial temperature of the beans, weight of the beans, or type of the coffee beans etc. For example, for beans from room temperature and beans from the refrigerator, the warm-up time may be different. Also, greater amount of beans may require longer warm up time to reach a pre-determined warm-up temperature.

Table 1(a) provides flavor comparison between Columbia SP coffee beans with and without being warmed up prior to brewing, wherein two groups of the coffee beans having different initial temperatures are used as examples. According to Table 1(a), the flavor of coffee beverage made from warmed up coffee beans may be rich and obvious and taste better than coffee beverage made from beans taken out of a refrigerator or even beans at room temperature. Similar results may be obtained for Brazil French coffee beans as illustrated in Table 1(b).

TABLE 1(a)

| Columbia SP (acid bean) | Sensory |
|---|---|
| Coffee bean at 2° C. | A bit watery. The taste is very flat and dull. |
| (e.g. from refrigerator) | Both acidity and bitterness and other |
| | taste are not obvious. A bit fruitier. |
| Coffee bean warmed-up | The taste becomes rich and obvious. More |
| from 2° C. to 85° C. | nutty. |
| Coffee bean at room | Good taste, a little acidic. |
| temperature 22° C. | |
| Coffee bean warmed-up | The taste is very rich; especially the acid is |
| from room-temperature | very obvious. |
| 22° C. to 85° C. | |

TABLE 1(b)

| Brazil French (bitter bean) | Sensory |
|---|---|
| Coffee bean at 2° C. | A bit watery. The taste is very flat and dull. |
| (e.g. from refrigerator) | Both acidity and bitterness and other |
| | taste are not obvious. |
| Coffee bean warmed-up | The taste becomes rich and obvious. |
| from 2° C. to 85° C. | |
| Coffee bean at room | Mild, a little bit bitter. |
| temperature 22° C. | |
| Coffee bean warmed-up | Strong and rich. the aroma is very good. |
| from room-temperature | |
| 22° C. to 85° C. | |

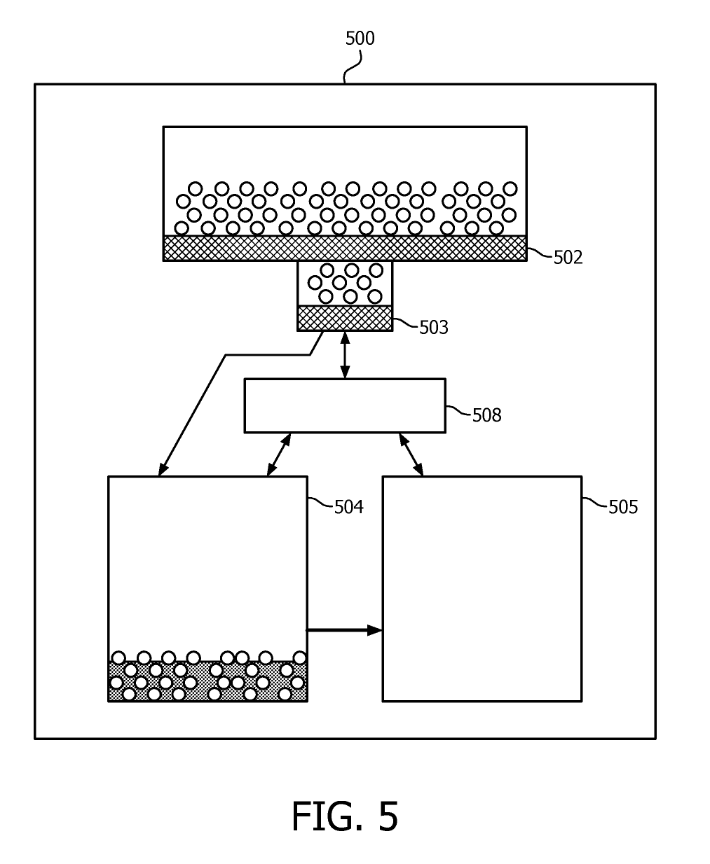

FIG. 5 illustrates another coffee machine 500 in accordance to one embodiment of the present disclosure. Coffee machine 500 may comprise a sub-container in addition to a main container, configured to hold coffee beans enough to make one or two cups of coffee, for example 10 to 20 grams of coffee beans. Coffee machine 500 may further comprise a sub warming up unit 503 attached to the sub-container, which may or may not be part of warming up unit 502 attached to the main container, configured to warm up the coffee beans contained in the sub-container.

In one embodiment, at block 102 warming up unit 502 may be configured to warm up the coffee beans in the main container to, for example 60° C., and warming up unit 503 may be configured to warm up coffee beans in the sub-container to, for example 80° C., based on instructions from determining unit 508. At block 104, grinding unit 504 may be configured to grind the coffee beans warmed up by warming up unit 503. At block 106, brewing unit 506 may be configured to brew coffee grounds from grinding unit 504 to make one or two cups of coffee beverage.

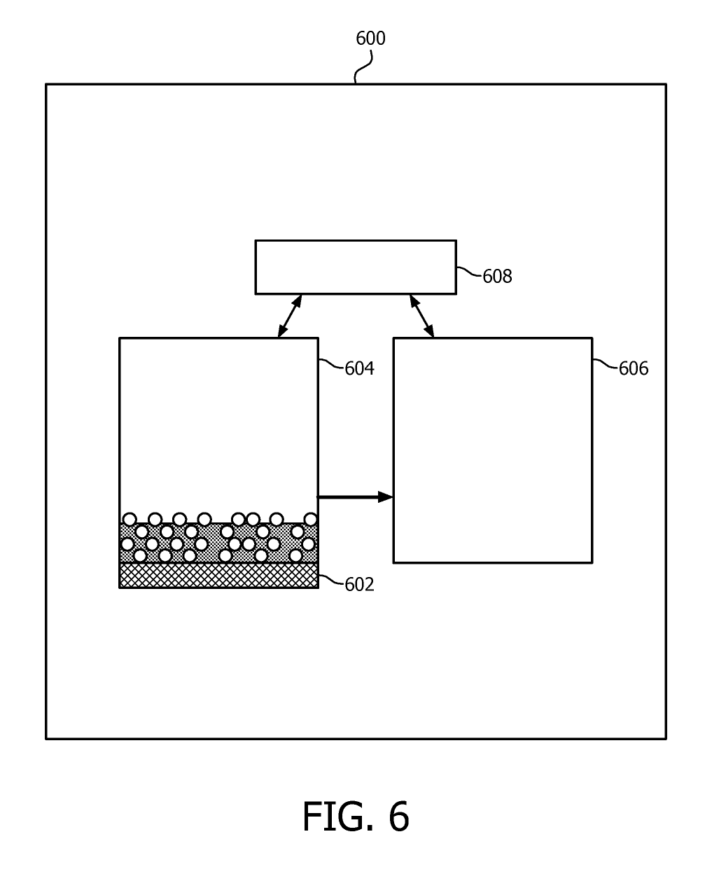

FIG. 2 illustrates a flowchart of another method for making coffee beverage in accordance with one embodiment of the present disclosure. FIG. 6 illustrates a coffee machine 600 which may be configured to perform the method illustrated in FIG. 2.

In one embodiment, coffee machine 600 may comprise a warming up unit 602 attached to grinding unit 604. At block 202, grinding unit 604 may be configured to grind coffee beans into coffee grounds. At block 204, warming up unit 602 may be configured to warm up a mixture of coffee beans and coffee grounds contained in grinding unit 604. At block 206, brewing unit 606 may be configured to brew coffee grounds into coffee beverage. In one embodiment, coffee machine 600 may further comprise a determining unit 608 configured to determine a warm-up temperature of the mixture of coffee beans and coffee grounds in grinding unit 604 warmed up by warming up unit 602.

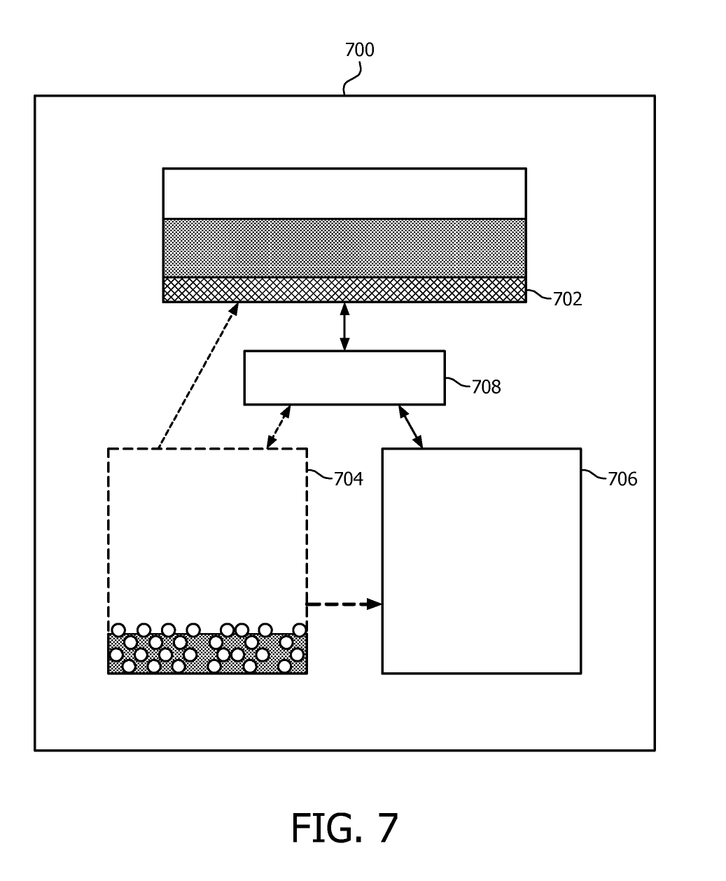

FIG. 3 illustrates a flowchart of yet another method for making coffee beverage in accordance with one embodiment of the present disclosure. FIG. 7 illustrates a coffee machine 700 which may be configured to perform the method illustrated in FIG. 3.

In one embodiment, coffee machine 700 may comprise a container configured to hold coffee grounds. Coffee machine 700 may further comprise a warming up unit 702 attached to the container. At block 302, coffee grounds may be obtained first. In one embodiment, coffee machine 700 may optionally comprise a grinding unit 704 configured to grind coffee beans into coffee grounds. In another embodiment, coffee grounds may be in commercially available format. At block 304, warming up unit 702 may be configured to warm up the coffee grounds. At block 306, brewing unit 706 may be configured to brew the warmed up coffee grounds into coffee beverage. In one embodiment, coffee machine 700 may further comprise a determining unit 708 configured to control said warming-up unit 702 by determining a warm-up temperature and warm-up time of the coffee grounds.

In various embodiments of the present disclosure, heating mechanism adopted by said warming up unit may be induction heating, light-wave heating, heating plate/spring, or other possible means that may be configured to increase temperature of coffee materials.

In various embodiments, coffee machines in the present disclosure may further comprise a thermometer (not shown) configured to measure the warm-up temperature of the coffee materials.

It should be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A method for making coffee beverage using a home used coffee machine, comprising:
grinding coffee beans into coffee grounds; and
brewing at least part of said coffee grounds to make the coffee beverage;
wherein further comprises a step of warming up coffee materials before brewing, said coffee materials are coffee beans and/or coffee grounds, and said step of warming up is performed without changing a roasting level of said coffee materials.

2. (canceled)

3. The method of claim 1, wherein said coffee materials are coffee beans and said step of warming up is performed before the step of grinding the coffee beans.

4. The method of claim 1, wherein said coffee materials are a mixture of coffee beans and coffee grounds and said step of warming up is performed while grinding.

5. The method of claim 1, wherein said coffee materials are coffee grounds and said step of warming up is performed after grinding.

6. The method of claim 1 further comprises a determining step prior to said step of warming up, wherein said determining step comprises
determining a warm-up temperature of said coffee materials and/or a lasting time during said step of warming up, based on weight, type, initial temperature of coffee materials or a desired flavor of said coffee beverage, wherein said warm-up temperature of the coffee materials is not higher than 190 degree Celsius.

7. The method of claim 1, wherein said step of warming up comprises warming up 10 to 20 grams of coffee materials;
wherein said step of brewing comprises
brewing said 10 to 20 grams of coffee materials to make coffee beverage.

8. The method of claim 1, wherein said step of warming up comprises:
warming up said coffee materials at a first temperature;
warming up at least a portion of said coffee materials at a second temperature, with said second temperature higher than said first temperature;
wherein said step of brewing comprises
brewing said at least a portion of the coffee materials to make coffee beverage.

9. A home used coffee machine, comprising:
a brewing unit, configured to brew coffee grounds into coffee beverage;
wherein further comprises a warming-up unit, configured to warm up coffee materials before brewing;—said coffee materials are coffee beans and/or coffee grounds, and said warming-unit is configured to warm up said coffee materials without changing a roasting level of said coffee materials.

10. The coffee machine of claim 9 further comprises a grinding unit coupled with said warming-up unit, configured to grind coffee beans into coffee grounds.

11. (canceled)

12. The coffee machine of claim 9, wherein said coffee materials are coffee beans and said warming-up unit is configured to warm up the coffee beans before grinding.

13. The coffee machine of claim 9, wherein said coffee materials are a mixture of coffee beans and coffee grounds, and said warming-up unit is configured to warm up the mixture while grinding.

14. The coffee machine of claim 9, wherein said coffee materials are coffee grounds and said warming-up unit configured to warm up the coffee grounds after grinding.

15. The coffee machine of claim 9, wherein said warming-up unit is configured to warm up said coffee materials at a first temperature and warm up at least a portion of said coffee materials at a second temperature, with said second temperature higher than said first temperature;
wherein said brewing unit is configured to brew said at least a portion of said coffee materials to make coffee beverage.
